(19) United States
(12) Patent Application Publication
(10) Pub. No.: US 2015/0301742 A1
(43) Pub. Date: Oct. 22, 2015

(54) HIGH-FREQUENCY PHYSICS SIMULATION SYSTEM

(71) Applicant: NanoTech Entertainment, Inc., San Jose, CA (US)

(72) Inventors: Aaron Hightower, Las Vegas, NV (US); Stephen Riesenberger, Henderson, NV (US)

(73) Assignee: NanoTech Entertainment, Inc.

(21) Appl. No.: 14/688,933

(22) Filed: Apr. 16, 2015

Related U.S. Application Data
(60) Provisional application No. 61/980,205, filed on Apr. 16, 2014.

(51) Int. Cl. G06F 3/0489; G06F 3/01; G06F 3/16; G07F 17/32; G06F 17/50; G06F 17/10

(52) U.S. Cl. CPC G06F 3/04897; G06F 17/5009; G06F 17/10; G06F 3/16; G07F 17/3209; G06F 3/016; G07F 17/3211; G07F 17/3269; G07F 17/3295

(57) ABSTRACT

Interactive computer graphics processing systems, and more particularly to the processing and coordinating of input systems and physics simulation engines with graphical display on video game systems with a gambling component that combines high-frequency physics simulation for gameplay with a high-frequency, low-latency input system in order to create a more realistic and immersive video game and/or virtual experience. The interactive computer graphics processing system comprises a user input system, a physics simulation system, a display system, and a software rendering system that are all in synchronous, multi-threaded operation when in use.

### CROSS-REFERENCE TO RELATED APPLICATION

This patent application claims the benefit of U.S. Provisional Patent Application Ser. No. 61/980,205, entitled “SYSTEM FOR COMBINING A HIGH-FREQUENCY PHYSICS SIMULATION FOR GAMEPLAY WITH A HIGH-FREQUENCY, LOW-LATENCY INPUT SYS[T]EM IN ORDER TO CREATE A MORE REALISTIC AND IMMERSIVE VIDEOGAME EXPERIENCE,” filed Apr. 16, 2014 which is incorporated in its entirety here by this reference.

### TECHNICAL FIELD

This invention relates to interactive computer graphics processing systems, and more particularly to the processing and coordinating of input systems and physics simulation engines for graphical display on video game systems with a gambling component.

### BACKGROUND

Many contemporary video games use physics simulation systems to emulate interactions between soft and rigid bodies to provide the dynamic behavior and collision detection of virtual objects in virtual environments imitating the real world. However, most video games only run their simulations, as well as the input systems that allow a user to interact with the virtual environment, at a frequency that matches their target display rate-typically at 60 Hz or lower. Some video games, specifically racing games, employ higher physics simulation rates of 100 Hz to 1000 Hz, as well as input devices (like optical mice and steering wheels) that run at a frequency of up to 1000 Hz. However, even video games that are the most sensitive to the arrival time of input data have an accuracy level of measuring only to the millisecond and therefore no frequency above 1000 Hz has ever been pertinent to the design of a video game in the gaming industry.

Video games in the casino and gambling industry have been using even lower frequencies than that of the gaming industry for its operating frequencies-typically operating in lock-step at only 60 Hz. Unlike ordinary video games, video games involving a gambling component require a high level of accuracy of measuring skill of an interactive simulation. Such games involving high stakes need to prevent the randomness of simulation error that affects the expression of a player's skill.

In recent years, techniques have been developed to improve the display quality of a display device. However, in terms of video games in the gambling or casino industry, the more important aspect that needs improvement involves the latency in translating a player's skillsets in operating gaming input devices to virtual advantages in those video games. Such barriers tend to involve mechanical failures of the input systems, input latency, and physics simulation latency.

For video games where a precise measure of a player's skill is desired, especially in a casino or arcade tournament setting where real cash prizes are awarded, an ordinary video game system's operating frequencies for both its physics simulation system and its input devices may be inadequate to measure the precise timing, such as to the nanosecond, as to when a player performs certain movements. For pinball, for example, many expert techniques employed on a real pinball game—such as cradle separations, drop-catching, and post-passing-become difficult or impossible to perform on the present video game systems due to low physics simulation system and/or input system frequency rates.

For the foregoing reasons there is a need for a system that combines high-frequency physics simulation, for gameplay involving a gambling component especially, with a high-frequency, low-latency input system in order to create a more realistic, accurate, and immersive video game and/or virtual experience.

### SUMMARY

The present invention is directed to interactive computer graphics processing systems, and more particularly to the processing and coordinating of input systems and physics simulation engines with graphical display on video game systems with a gambling component that combines high-frequency physics simulation for gameplay with a high-frequency, low-latency input system in order to create a more realistic, accurate, and immersive video game and/or virtual experience. The interactive computer graphics processing system comprises components such as a user input system, a physics simulation system, a display system, and a software rendering system that are all in synchronous, multi-threaded operation when in use.

Many contemporary video games use physics simulation engines to emulate interactions between soft and rigid bodies, but most games resign to run their simulations at a frequency that matches their target display rate-typically at 60 Hz or lower. The present invention provides both a high frequency physics simulation system rate and a high frequency user input system rate for the specific application of measuring a player's skills of performance of a game. The intent of the invention is to precisely measure a player's skill in a videogame in both casino and arcade tournament settings—where real cash prizes and jackpots are at stake. The present invention eliminates mechanical failure, input latency, and physics simulation system latency in order to remove barriers between the video game and the skill of the player. It is important to note that the physics simulation system rate and the input system rate do not need to be the same, but they should be decoupled from the display rate of the videogame. For a more accurate measure of a player's skill, it is desired that the physics simulation system rate and input system rate are higher than the display rate.

In some embodiments, an application of the present invention is a high limit advantage play video pinball game, and a user input system, a video display system, a software rendering system, and a physics simulation system are all in synchronous, multi-threaded operation when the player is playing. Additionally, each of the related technologies may operate at a different frequency and may be independent from each other related technology concerning their respective operating frequency. In some embodiments, the physics simulation system and display system operate at 1000 Hz (1000 times per second) and 120 Hz respectively, while the input system operates at 3.5 GHz (3.5 million times per second). The independent operating frequencies of each of these systems exceeds commonly acceptable standards in casino and skill-based video game play, where all three systems would operate in lock-step at only 60 Hz.

Furthermore, in order to compensate for the differences in operating frequencies between the various related technologies, the present invention provides data from a faster system operating at a higher frequency to one operating at a lower frequency. The input system can provide the physics simulation system with a time value representing the exact moment that the input data arrived. The physics simulation system can then measure how long that input data has been present before deciding how the input data should affect a simulation. In other words, when an input data is present for only a portion of simulated frame, the result can potentially make a difference even though the physics simulation system operates at slower frequency.

The present invention aims to minimize the inherent delay in multiple player feedback loops by providing data from a faster system operating to a higher frequency to one operating at a lower frequency to provide the highest fidelity in the measurement of a player's skill or preciseness of a user's input.

### BRIEF DESCRIPTION OF DRAWINGS

FIG. 1 is a high-level diagram of an exemplary interactive computer graphics processing system in accordance with an embodiment of the present disclosure.

### DETAILED DESCRIPTION OF THE INVENTION

The detailed description set forth below in connection with the appended drawing is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

It will be understood that, although the terms first, second, etc. may be used herein to describe various elements, these elements should not be limited by these terms. These terms are only used to distinguish one element from another. For example, a first gesture could be termed a second gesture, and, similarly, a second gesture could be termed a first gesture, without departing from the scope of the present invention.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Systems, apparatus, and methods described herein may be implemented using digital circuitry, or using one or more computers using well known computer processors, memory units, storage devices, computer software, and other components. Typically, a computer includes a processor for executing instructions and one or more memories for storing instructions and data. A computer may also include, or be coupled to, one or more storage devices, such as one or more magnetic disks, internal hard disks and removable disks, optical disks, etc.

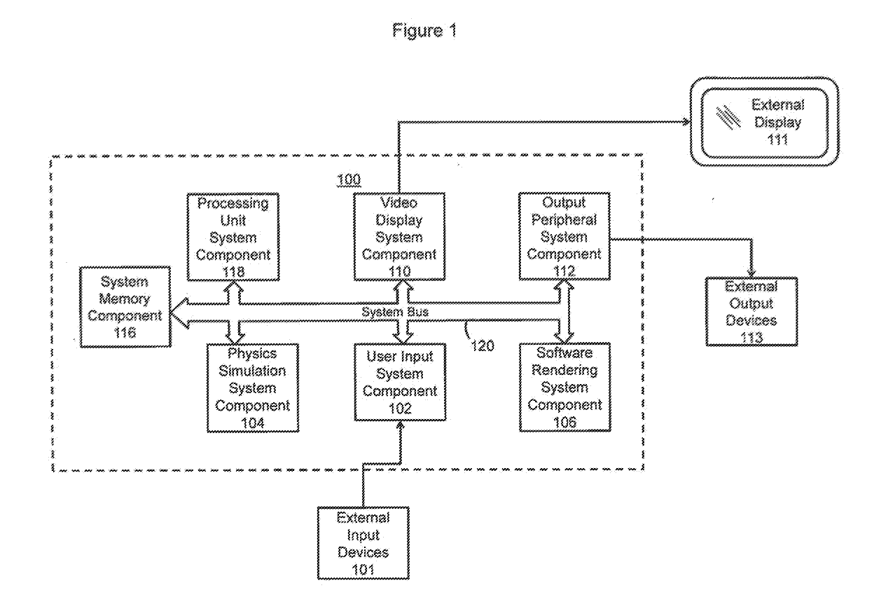

A high-level block diagram of an exemplary interactive computer graphics processing system 100 that may be used to implement systems, apparatus, and methods described herein is illustrated in FIG. 1. Referring to FIG. 1, the present invention comprises a user input system component 102, a physics simulation system component 104, a software rendering system component 106, a video display system component 110, an output peripheral system component 112, a system memory component 116, a processing unit component 118, and a system bus 120 that connects said components of the interactive computer graphics processing system 100.

The user input system component 102 operates at approximately 1000 Hz or higher, preferably at approximately 5000 Hz or higher, more preferably at approximately 1.5 GHz or higher, even more preferably at approximately 3 GHz or higher, and most preferably at approximately 3.5 GHz or higher. The user input system component 102 may receive input data regarding an arrival time on an interrupt-driven system from external input devices 101, such as leaf-switch buttons. The interrupt-driven system samples an internal clock of the user input system component 102 at the moment that the user input system component 102 services an interruption by immediately loading a program counter of the user input system component 102 to jump to a special interrupt service routine when the input data is observed. The user input system component 102 then provides the physics simulation system component 104 with a time value representing the exact arrival time of the input data. For gambling purposes where stakes are high, operating frequencies at a range from about 1000 Hz to about 3.5 GHz or higher are necessary to provide sensitivity down to nanoseconds that may determine a win or loss condition.

The physics simulation system component 104 operates at approximately 200 Hz or higher, preferably at approximately 500 Hz or higher, even more preferably at 800 Hz or higher, and most preferably at approximately 1000 Hz or higher. The physics simulation system component 104 then measures how long the input data has been present before deciding how the input data should affect a simulation, and then calculates and produces physics simulation data that emulate the physical responses in the real world.

The software rendering system component 106 receives physics simulation data from the physics simulation system component 104 to compute and provide screen buffer data, which is graphical data for all motion parameters to produce a series of final images to send to the video display system component 110.

The video display system component 110 operates at approximately 60 Hz or higher, preferably at approximately 75 Hz or higher, even more preferably at 100 Hz or higher, and most preferably at approximately 120 Hz or higher. The video display system component 110 receives the screen buffer data and couples with an external display 111 with a refresh rate from about 60 Hz to about 120 Hz or higher. The video display system component 110 renders the screen buffer data based to match the operating frequency of the external display 111, such that the external display displays an accurate series of digital graphics at the appropriate times.

For interleaving the physics simulation system 104 and the video display system component 110, the physics simulation system 104 is iterated multiple times in the same thread as the video display system component 110 and in each instance, a real-time clock is observed. For example, the physics simulation system 104 has an operating frequency of 1000 Hz and the video display system component 110 has an operating frequency of 120 Hz. Then, one-third of the time, after the video display system component 110 produces one iteration, the physics simulation system 104 has produced nine iterations and two-thirds of the time, after the video display system component 110 produces one iteration, the physics simulation system 104 has produced eight iterations. To that effect, when the video display system component 110 produces an iteration, it captures the most recent iteration from the physics simulation system 104, and for the forgoing example, it would capture every eighth iteration two-thirds of the time and every ninth iteration one-third of time. Thus, while the physics simulation system 104 with a frequency of 1000 Hz is iterating, the physics simulation system 104 is adding 1 millisecond to the total amount of time the physics simulation system 104 has been updated until the time value equals or exceeds the current real-time clock.

In another example, the physics simulation system 104 has an operating frequency of 500 GHz and the video display system component 110 has an operating frequency of 120 Hz. Then, one-sixth of the time, after the video display system component 110 produces one iteration, the physics simulation system 104 has produced five iterations and five-sixths of the time, after the video display system component 110 produces one iteration, the physics simulation system 104 has produced four iterations. To that effect, when the video display system component 110 produces an iteration, it captures the most recent iteration from the physics simulation system 104, and for the forgoing example, it would capture every fourth iteration five-sixths of the time and every fifth iteration one-sixth of time.

The advantage of this technique of interleaving, as opposed to creating a separate and/or real-time thread, is that by grouping all the physics simulation system component 104 iterations to be performed at the same moment in real-time, an improvement in cache-coherency can be made.

The output peripheral system component 112 also receives physics simulation data from the physics simulation system component 104 and may couple with external output devices 113, such as speakers and tactile feedback components, to produce the corresponding sounds and tactile feedback.

The system memory component 116 stores memory accumulated from the user input system component, the physics simulation system component, the software rendering system component, the video display system component, and the output peripheral system component for saving user data, reports of errors, programming data, and other miscellaneous data.

In this example, the processing unit component 118 executes multiple threads of synchronous operations of the user input system component, the physics simulation system component, the software rendering system component, the video display system component, and the output peripheral system component with the user input system component, the physics simulation system component, the software rendering system component, the video display system component, and the output peripheral system component generally operating at different frequencies and independent from one another with regard to their individual operating frequencies.

The system memory component 116 may comprise a tangible non-transitory computer readable storage medium. By way of example, and not limitation, such non-transitory computer-readable storage medium can include random access memory (RAM), high-speed random access memory (DRAM), static random access memory (SRAM), double data rate synchronous dynamic random access memory (DDRRAM), read-only memory (ROM), erasable programmable read-only memory (EPROM), electrically erasable programmable read-only memory (EEPROM), flash memory, or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

In use, a user interacts with the interactive computer graphics processing system 100 by engaging with the external input devices 101. Because the user input system component 102 may operate as fast as 3.5 GHz or higher, for example, it is able to capture a user's engagement at up to 3.5 million times or more per second and reduce input latency to a few nanoseconds whilst having the interactive computer graphics processing system 100 working synchronously and in a multi-threated operation. Whereas, in the gambling and casino industry, system components operate in lock-step at only 60 Hz.

In various embodiments, the method steps described herein may be performed in an order different from the particular order described or shown. In other embodiments, other steps may be provided, or steps may be eliminated, from the described methods. Thus, the method steps can be defined by computer program instructions stored in the system memory component 116 and controlled by the processing unit system component 118 executing the computer program instructions.

The processing unit component 118 can include, among others, special purpose processors with software instructions incorporated in the processor design and general purpose processors with instructions in the system memory component 116, to control the processing unit component 118, and may be the sole processor or one of multiple processors of the interactive computer graphics processing system 100. The processing unit component 118 may be a self-contained computing system, containing multiple cores or processors, a bus, memory controller, cache, etc. A multi-core processor may be symmetric or asymmetric. The processing unit component 118 and system memory component 116 may include, be supplemented by, or incorporated in, one or more application-specific integrated circuits (ASICs) and/or one or more field programmable gate arrays (FPGAs). It can be appreciated that the disclosure may operate on the interactive computer graphics processing system 100 with one or more processing unit components 118 or on a group or cluster of computers networked together to provide greater processing capability.

One skilled in the art will recognize that an implementation of the interactive computer graphics processing system 100 or computer systems may have other structures and may contain other components as well, and that FIG. 1 is a high level representation of some of the components of such a computer system for illustrative purposes.

What is claimed is:

1. An interactive computer game, comprising:
a. a user input system component, operating at approximately 3 GHz or higher, that receives input data and an arrival time of the input data on an interrupt-driven system from leaf-switch buttons, wherein the interrupt-driven system samples an internal clock of the user input system component at a moment that the user input system component services an interruption by immediately loading a program counter of the user input system component to jump to a special interrupt service routine when the input data is observed and generates a time value representing an exact arrival time of the input data;
b. a physics simulation system component, operating at approximately 800 Hz or higher, that receives the time value representing the exact arrival time of the input data from the user input system component and measures how long the input data has been present before deciding how the input data should affect a simulation, and calculates and produces physics simulation data that emulate physical responses in a real world;
c. a software rendering system component that receives the physics simulation data from the physics simulation system component to compute and provide screen buffer data, which is graphical data for all motion parameters to produce a series of final images;
d. a video display system component, operating at approximately 100 Hz or higher, that receives the screen buffer data and couples with an external display with a refresh rate of approximately 100 Hz or higher and renders the screen buffer data to match an operating frequency of the external display, such that the external display displays an accurate series of digital graphics at appropriate times;
e. an output peripheral system component that receives the physics simulation data from the physics simulation system component and couples to speakers and tactile feedback components to produce the corresponding sounds and tactile feedback, respectively;
f. a system memory component that stores memory accumulated from the user input system component, the physics simulation system component, the software rendering system component, the video display system component, and the output peripheral system component for saving user data, reports of errors, programming data, and other miscellaneous data;
g. a processing unit component that executes multiple threads of synchronous operations of the user input system component, the physics simulation system component, the software rendering system component, the video display system component, and the output peripheral system component by a processing unit component, with the user input system component, the physics simulation system component, the software rendering system component, the video display system component, and the output peripheral system component generally operating at different frequencies and independent from one another with regard to their respective operating frequencies; and
h. a system bus that connects the user input system component, the physics simulation system component, the software rendering system component, the video display system component, the output peripheral system component, the system memory component, and the processing unit component,
i. wherein the physics simulation system and the video display system component are interleaved in the same thread, and
j. wherein the interactive computer game operates when a user is gambling real money on certain results based on skill-sets pertaining to how and when the user operates the leaf-switch buttons.

2. An interactive computer graphics processing system, comprising:
a. a user input system component, operating at approximately 1000 Hz or higher, that receives input data regarding the arrival time on an interrupt-driven system from external input devices, wherein the interrupt-driven system samples an internal clock of the user input system component at the moment that the user input system component services an interruption by immediately loading a program counter of the user input system component to jump to a special interrupt service routine when the input data is observed and generates a time value representing the exact arrival time of the input data;
b. a physics simulation system component, operating at approximately 200 Hz or higher, that receives the time value representing the exact arrival time of the input data from the user input system component and measures how long the input data has been present before deciding how the input data should affect a simulation, and calculates and produces physics simulation data that emulate physical responses in a real world;
c. a software rendering system component that receives physics simulation data from the physics simulation system component to compute and provide screen buffer data, which is graphical data for all motion parameters to produce a series of final images to send the video display system component;
d. a video display system component, operating at approximately 60 Hz or higher, that receives the screen buffer data and couples with an external display with a refresh rate of approximately 60 Hz or higher and renders the screen buffer data to match the operating frequency of the external display, such that the external display displays an accurate series of digital graphics at the appropriate times,
e. wherein the physics simulation system and the video display system component are interleaved in the same thread, and
f. wherein the interactive computer graphics processing system operates such that a user is gambling real money on certain results based on skill-sets pertaining to how and when the user operates the external input devices.

3. The interactive computer graphics processing system as claimed in claim 2 wherein the operating frequency for the user input system component is approximately 5000 Hz or higher.

4. The interactive computer graphics processing system as claimed in claim 2 wherein the operating frequency for the user input system component is approximately 1.5 GHz or higher.

5. The interactive computer graphics processing system as claimed in claim 2 wherein the operating frequency for the user input system component is approximately 3.5 GHz or higher.

6. The interactive computer graphics processing system as claimed in claim 2 wherein the operating frequency for the physics simulation system component is approximately 500 Hz or higher.

7. The interactive computer graphics processing system as claimed in claim 2 wherein the operating frequency for the physics simulation system component is approximately 1000 Hz or higher.

8. The interactive computer graphics processing system as claimed in claim 2 wherein the operating frequency for the video display system component is approximately 75 Hz or higher.

9. The interactive computer graphics processing system as claimed in claim 2 wherein the operating frequency for the video display system component is approximately 120 Hz or higher.

10. An interactive computer graphics processing system, comprising one or more processors, memory; and one or more programs, wherein the one or more programs are stored in the memory and configured to be executed by the one or more processors, the one or more programs including instructions:
a. to receive input data regarding the arrival time on an interrupt-driven system from external input devices through a user input system component, operating at a frequency of approximately 1000 Hz or higher, wherein the interrupt-driven system samples an internal clock of the user input system component at the moment that the user input system component services an interrupt by immediately loading a program counter of the user input system component to jump to a special interrupt service routine when the input data is observed and generates a time value representing the exact arrival time of the input data;
b. to measure how long the input data has been present before deciding how the input data should affect a simulation and to calculate and produce physics simulation data that emulate the physical responses in the real world through a physics simulation system component, operating at approximately 200 Hz or higher, that receives the time value representing the exact arrival time of the input data from the user input system component;
c. to compute and provide screen buffer data, which is graphical data for all motion parameters to produce a series of final images, through a software rendering system component to send to a video display system component;
d. to render the screen buffer data to match the operating frequency of an external display, by the video display system component, operating at a frequency approximately 60 Hz or higher, that receives the screen buffer data and couples with an external display with a refresh rate of approximately 60 Hz or higher, such that the external display displays an accurate series of digital graphics at the appropriate times; and
e. to send corresponding information to external output devices by an output peripheral system component that receives physics simulation data from the physics simulation system component,
f. wherein the physics simulation system and the video display system component are interleaved in the same thread, and
g. wherein the interactive computer graphics processing system operates when a user is gambling real money on certain results based on skill-sets pertaining to how and when the user operates the external input devices.

11. The interactive computer graphics processing system as claimed in claim 10 wherein the external input devices are leaf-switch buttons.

12. The interactive computer graphics processing system as claimed in claim 10 wherein the external output devices are speakers and tactile feedback components.

13. The interactive computer graphics processing system as claimed in claim 10 wherein the one or more programs include further instructions to execute multiple threads of synchronous operations of the user input system component, the physics simulation system component, the software rendering system component, the video display system component, and the output peripheral system component by a processing unit component, with the user input system component, the physics simulation system component, the software rendering system component, the video display system component, and the output peripheral system component generally operating at different frequencies and independent from one another with regard to their individual operating frequencies.

14. The interactive computer graphics processing system as claimed in claim 10 wherein the one or more programs include further instructions to store memory accumulated from the user input system component, the physics simulation system component, the software rendering system component, the video display system component, and the output peripheral system component by a system memory component for saving user data, reports of errors, programming data, and other miscellaneous data.

15. The interactive computer graphics processing system as claimed in claim 10 wherein the operating frequency for the user input system component is approximately 5000 Hz or higher.

16. The interactive computer graphics processing system as claimed in claim 10 wherein the operating frequency for the user input system component is approximately 1.5 GHz or higher.

17. The interactive computer graphics processing system as claimed in claim 10 wherein the operating frequency for the user input system component is approximately 3.5 GHz or higher.

18. The interactive computer graphics processing system as claimed in claim 10 wherein the operating frequency for the physics simulation system component is approximately 1000 Hz or higher.

19. The interactive computer graphics processing system as claimed in claim 10 wherein the operating frequency for the video display system component is approximately 75 Hz or higher.

20. The interactive computer graphics processing system as claimed in claim 10 wherein the operating frequency for the video display system component is approximately 120 Hz or higher.
